(19) United States
(12) Patent Application Publication
(10) Pub. No.: US 2026/0062059 A1
(43) Pub. Date: Mar. 5, 2026

(54) FENDER STRUCTURE FOR VEHICLE

(71) Applicant: TOYOTA JIDOSHA KABUSHIKI KAISHA, Toyota-shi (JP)

(72) Inventor: Taichi MINEI, Toyota-shi (JP)

(73) Assignee: TOYOTA JIDOSHA KABUSHIKI KAISHA, Toyota-shi (JP)

(21) Appl. No.: 19/215,958

(22) Filed: May 22, 2025

(30) Foreign Application Priority Data
Aug. 28, 2024 (JP) 2024-146934

(51) Int. Cl. B62D 25/02; B62D 29/04

(52) U.S. Cl. CPC B62D 25/02; B62D 29/043

(57) ABSTRACT

The fender structure includes a fender panel and a tubular member. The fender panel is made of resin. The tubular member is composed of an air duct and a protector. The fender panel is adjacent to the side door of the vehicle in the vehicle front-rear direction. The tubular member is disposed inside the fender panel in the vehicle width direction. The tubular member extends in the vehicle front-rear direction. The tubular member further comprises a downstream opening. The downstream opening is directed toward the side door. A tube end portion of the tubular member surrounding the downstream opening is coupled to an end portion of the fender panel on the side door side.

### CROSS-REFERENCE TO RELATED APPLICATION

This application claims priority to Japanese Patent Application No. 2024-146934 filed on Aug. 28, 2024. The disclosure of the above-identified application, including the specification, drawings, and claims, is incorporated by reference herein in its entirety.

### BACKGROUND

### 1. Technical Field

A fender structure for a vehicle is disclosed in the present specification.

### 2. Description of Related Art

Japanese Unexamined Patent Application Publication No. 5-155357 (JP 5-155357 A) discloses a fender of a vehicle. The fender is made of resin. Resin fenders are lighter than metal fenders. Accordingly, adopting a resin fender enables the weight of a vehicle to be reduced.

In Japanese Unexamined Patent Application Publication No. 2001-071942 (JP 2001-071942 A), a functional component such as an energy absorbing member or the like is attached to a rear side of a resin fender.

In e-tron GT Electronic Catalogue, [online], pp. 12 to 13, 2023 March, Audi Japan, [retrieved Aug. 13, 2024], Internet <https://catalogue.audi.co.jp/catalogue_audi/catalogue_e-trongt/>, an air duct is provided at a rear end of a fender. Air in a wheel house is discharged rearward from a vehicle by an air duct. That is to say, increase in air pressure within the wheel house is suppressed by the air duct. As a result, reduction in downforce of the vehicle is suppressed.

### SUMMARY

Incidentally, the fender panel is disposed close to a door panel. A gap is provided between the door panel and the fender panel, in order to keep the door panel and the fender panel from interfering with each other when a door is opened and closed. Shortening (narrowing) this gap enables a sophisticated assembly structure to be included in vehicle appearance.

Now, resin fender panels have a higher coefficient of thermal expansion as compared to metal fender panels. For example, the linear expansion coefficient of acrylonitrile-butadiene-styrene (ABS) resin is two times or more the linear expansion coefficient of iron. When thermal expansion of resin material is taken into account, reducing the gap between the fender panel and the door panel while suppressing interference at the time of opening and closing the door is difficult.

Accordingly, the present specification discloses a fender structure of a vehicle in which the gap between the door panel and the resin fender panel can be reduced further than that in the related art.

A fender structure for a vehicle is disclosed in the present specification. The fender structure includes a fender panel and a tubular member. The fender panel is made of resin. Also, the fender panel is adjacent to a side door of the vehicle in a vehicle front-rear direction. The tubular member is disposed on an inner side from the fender panel in a vehicle width direction. Also, the tubular member extends in the vehicle front-rear direction. The tubular member further includes an opening. The opening is directed toward the side door. A tube end portion of the tubular member surrounding the opening is joined to an end portion of the fender panel, on a side of the fender panel toward the side door.

According to the above configuration, the end portion of the resin fender panel on the side door side is restrained by the tubular member. Accordingly, deformation of the end portion due to heat is suppressed.

Also, in the above configuration, the opening of the tubular member may be disposed on an outer side of an outer face of a door outer panel of the side door in the vehicle width direction. In this case, the fender panel is provided with an edge on the side thereof toward the side door. The door outer panel is provided with an edge on a side thereof toward the fender panel. Vehicle front-rear direction positions of these edges are aligned.

According to the above configuration, the edge of the fender panel and the edge of the door outer panel are disposed offset from each other in the vehicle width direction. Accordingly, interference with respect to the door outer panel due to thermal deformation of the fender panel is suppressed. In this arrangement, the vehicle front-rear direction positions of the edge of the fender panel and the edge of the door outer panel are aligned with each other, thereby improving aesthetics of vehicle appearance.

Also, in the above configuration, the side door may be a front door. The fender panel may be disposed forward from the front door. An upstream opening is formed at an upstream end of the tubular member. The upstream opening faces a wheel house. A bottom face of the tubular member is inclined ascending from an upstream side toward a downstream side.

There are cases in which water that is swept up in the wheel house flows into the tubular member. In this case, advance of water is suppressed, due to the bottom face of the tubular member being inclined ascending. As a result, adhesion of water to the front door is suppressed.

Also, in the above configuration, an opening width of the opening on the downstream side of the tubular member along the vehicle width direction may vary along a vehicle up-down direction. In this case, a rectifying plate is disposed at a portion where the opening width is greatest in the opening on the downstream side of the tubular member.

According to the above configuration, the shape of the opening is maintained by the rectifying plate.

Also, in the above configuration, the tube end portion of the tubular member and the end portion of the fender panel may be joined by adhesive tape.

According to the above configuration, the end portion of the fender panel is continuously restrained to the tube end portion of the tubular member as compared with a case of being fastened by a clip with a space therebetween.

Also disclosed in the present specification is a fender structure for a vehicle. The fender structure includes a side door, a fender panel, and a tubular member, of the vehicle. The side door includes an outer panel that is made of metal. The fender panel is made of resin. The fender panel is provided adjacent to either forward or rearward of the side door in a vehicle front-rear direction. The tubular member is disposed on an inner side of the fender panel in a vehicle width direction. Further, the tubular member is fixed to a front end and a rear end of the fender panel. An opening at a front end or a rear end of the tubular member is directed in a direction along an outer face of the outer panel of the side door.

According to the fender structure of the vehicle disclosed in the present specification, the gap between the door panel and the resin fender panel can be reduced as compared with conventional arrangements.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of a vehicle illustrating a fender structure according to the present embodiment;

FIG. 2 is a perspective view illustrating a structure of a fender panel and a side door;

FIG. 3 is a perspective view illustrating a fender panel and its peripheral structure;

FIG. 4 is a perspective view illustrating the fender panel and its peripheral structure, and is a perspective view in which the composition of FIG. 3 is reversed;

FIG. 5 is a perspective view of the air duct and sealant removed from FIG. 4;

FIG. 6 is a cross-sectional A-A view of FIG. 1; and

FIG. 7 is an A-A cross-sectional view illustrating a fender structure according to another embodiment of the present disclosure.

### DETAILED DESCRIPTION OF EMBODIMENTS

Hereinafter, a fender structure of a vehicle according to the present embodiment will be described with reference to the drawings. The shapes, materials, numbers, and numerical values described below are illustrative examples. These shapes and the like can be appropriately changed according to the specifications of the fender structure of the vehicle. In the following, like elements are given the same reference signs in all drawings.

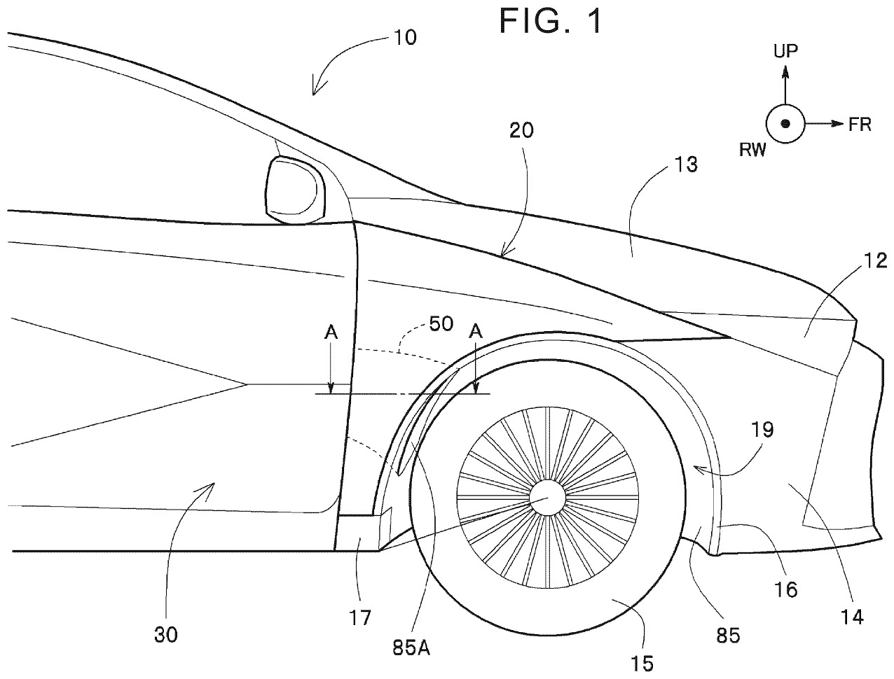

In addition, in FIGS. 1 to 7, a Cartesian coordinate system including a FR axis, a RW axis, and a UP axis is used to represent the positions and orientations of the respective configurations. FR shaft is a vehicle front-rear direction axis. RW shaft is a vehicle width direction shaft. UP shaft is a vehicle up-down direction shaft. FR shaft has a forward direction in front of the vehicle. The vehicle right side of RW shaft is set to the positive direction. The upper part of UP shaft is the positive direction.

### 1. Overall Configuration

FIG. 1 illustrates a right side view of the vehicle 10. On the basis of the symmetrical structure of the vehicle 10, the left side surface of the vehicle 10 also has the same structure as that of FIG. 1.

The vehicles 10 are, for example, battery electric vehicle (BEV). Alternatively, the vehicles 10 may be internal combustion engine vehicles or hybrid electric vehicle.

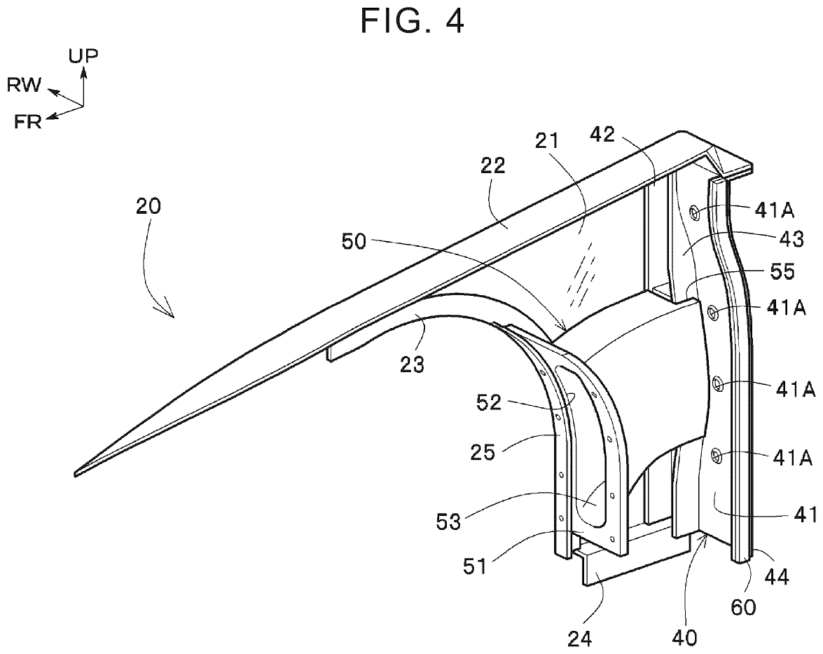

The fender structure of the vehicle according to the present embodiment includes a fender panel 20 and a tubular member. The tubular member includes a protector 40 (see FIG. 4) and an air duct 50.

Referring to FIG. 1, a fender panel 20 is provided as a panel material on a side surface of the vehicle 10. The fender panel 20 is, for example, a front fender panel. Engine or motor compartments are sandwiched between the left and right fender panels 20, 20. The bonnet hood 13 is arranged to cover the upper part of the engine compartment or the motor compartment. A headlamp 12 and a bumper panel 14 are disposed in front of the fender panel 20.

Further, a lower end portion in front of the fender panel 20 has an arc shape. A wheel 15 is arranged in this lower part. That is, the lower portion of the fender panel 20 is the wheel house 19. A fender liner 85 is provided on the vehicle width direction inner side of the wheel 15. An outer end portion of the fender liner 85 in the vehicle width direction is connected to the fender panel 20.

A side door 30 is provided adjacent to the fender panel 20 in the vehicle front-rear direction. In this embodiment, a side door 30 is provided behind the fender panel 20. The side door 30 is a front door in this embodiment.

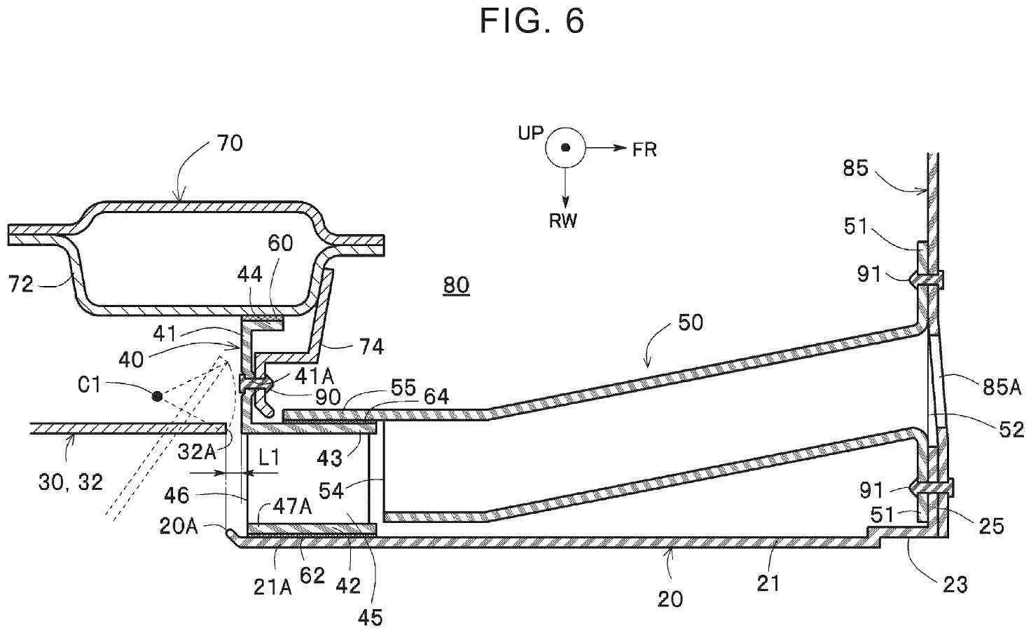

As will be described later, the fender panel 20 is made of resin. In order to suppress deformation of the fender panel 20 due to thermal expansion, the fender structure according to the present embodiment includes a tubular member. The tubular member includes an air duct 50 and a protector 40 (see FIG. 4). As will be described later, the downstream opening 46 (see FIG. 6) of the tubular member is surrounded by the tube end portion 47A. A tube end portion 47A is coupled to an end portion 21A of the fender panel 20 closer to the side door 30. For example, the tube end portion 47A is coupled to the end portion 21A by an adhesive tape 62. That is, the end portion 21A of the fender panel 20 is restrained by the tube end portion 47A. As a result, a change in the position of the end portion 21A due to thermal expansion is suppressed.

### 2. Side Door

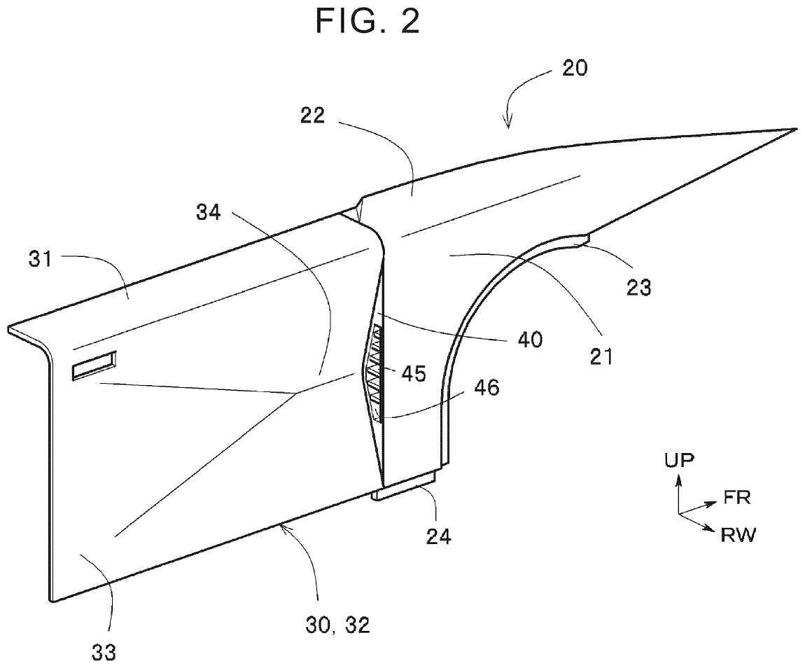

Referring to FIGS. 1 and 2, the side door 30 is, for example, a front door. The side door 30 includes a door outer panel 32 as an outer plate. The door outer panel 32 is made of metal. For example, the door outer panel 32 is formed by pressing a metal panel.

Referring to FIG. 2, the door outer panel 32 includes an upper plate portion 31 and a side plate portion 33. The upper plate portion 31 is disposed on a horizontal plane. The side plate portion 33 extends in a substantially vertical direction. Here, with respect to the front portion of the side plate portion 33, a recessed portion 34 is formed in the up-down direction center portion. That is, the front and up-down direction center portions of the side plate portion 33 are recessed inward in the vehicle width direction.

A downstream opening 46 is provided to correspond to the recessed portion 34. The downstream opening 46 is directed toward the door outer panel 32 of the side door 30. More specifically, the downstream opening 46 is directed in a direction along the outer surface of the door outer panel 32. The gas exhaled from the downstream opening 46 flows to the rear of the vehicle along the door outer panel 32.

FIG. 6 illustrates A-A cross-section of FIG. 1. FIG. 6 illustrates a rotation center C1 of the side door 30. A state in which the side door 30 is opened is indicated by a broken line. Further, the trajectory of the edge 32A of the door outer panel 32 is indicated by a broken line in an arc shape.

The edge 32A of the door outer panel 32 on the side of the fender panel 20 is, for example, a distal end portion of the side door 30. The gap L1 is set so that the edge 32A does not interfere with the fender panel 20 and the protector 40. The distance between the main surface portion 41 of the protector 40 and the edge 32A of the door outer panel 32 in the vehicle front-rear direction is a gap L1.

Further, as will be described later, the downstream opening 46 is disposed outside the outer surface of the side door 30 in the vehicle width direction. Accordingly, the edge 20A of the fender panel 20 closer to the side door 30 and the edge 32A of the door outer panel 32 are spaced apart from each other in the vehicle width direction. That is, the arrangement is such that interference between the two is avoided. Therefore, the end edge 20A of the fender panel 20 and the end edge 32A of the door outer panel 32 are aligned with each other in the vehicle front-rear direction. That is, the end edge 20A of the fender panel 20 and the end edge 32A of the door outer panel 32 coincide with each other in the vehicle front-rear direction.

When the vehicle is viewed from the side, there is no gap between the edge 20A of the side door 30 and the edge 32A of the door outer panel 32. That is, an elaborate assembly structure for the fender panel 20 and the side door 30 is included in the vehicle appearance.

### 3. Fender Panel

Referring to FIG. 1, the fender panel 20 is a panel component for forming a wheel arch. The fender panel 20 is adjacent to any one of the vehicle front-rear directions of the side door 30. In this embodiment, a side door 30 is provided behind the fender panel 20. The side door 30 is a front door in this embodiment.

The fender panel 20 is, for example, a front fender panel. That is, the fender panel 20 is disposed in front of the side door 30. The fender panel 20 is made of resin. For example, the fender panel 20 is made of polypropylene as a main material.

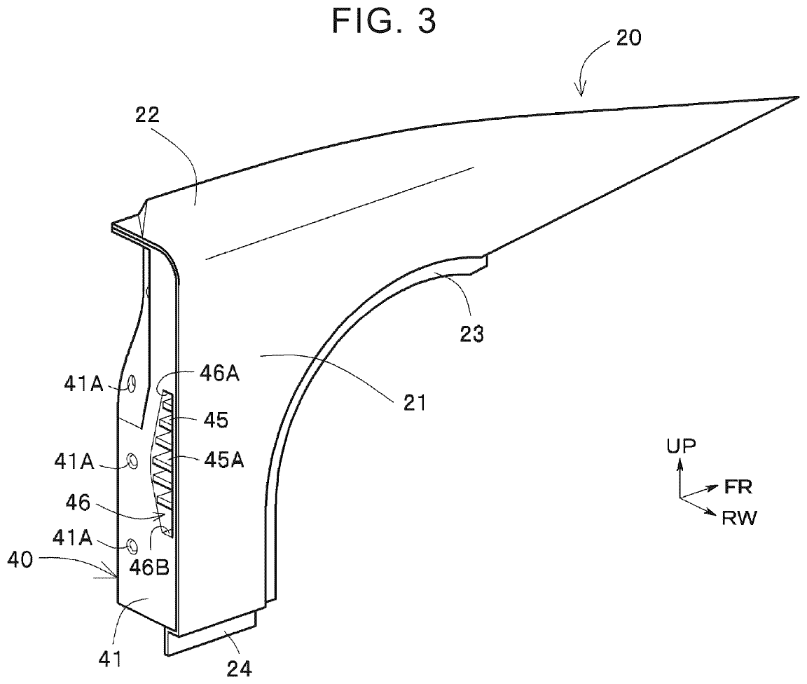

Referring to FIGS. 2 and 3, the fender panel 20 includes a side plate portion 21 and an upper plate portion 22. A lower portion of the side plate portion 21 has an arc shape. A fender molding 16 (see FIG. 1) which is a decorative part is attached to the arc portion. Further, a mud guard 17 is attached to a lower end portion of the fender panel 20.

Referring to FIG. 3, flanges 23 and 24 are formed in the side plate portion 21. The flanges 23 and 24 are disposed on the inner side in the vehicle width direction as compared with the outer surface (exposed surface) of the side plate portion 21. A fender molding 16 (see FIG. 1) is attached to the flange 23. A mud guard 17 is attached to the flange 24.

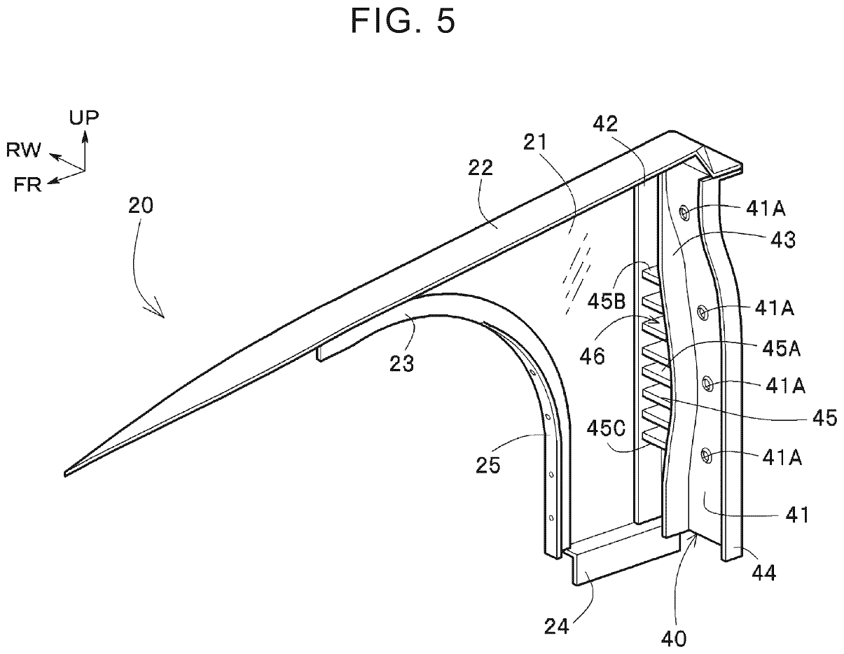

Still referring to FIG. 5, a further flange 25 is formed at the front end of the flange 23. The flange 25 extends inward in the vehicle width direction. Further, the flange 25 faces the front of the vehicle. As will be described later, the flange 51 of the air duct 50 (see FIG. 4) is attached to the flange 25.

Referring to FIG. 2, the side plate portion 21 of the fender panel 20 has, for example, a planar shape. While the side plate portion 21 has a planar shape, the side plate portion 33 of the door outer panel 32 includes a recessed portion 34. That is, the side plate portion 21 of the fender panel 20 and the side plate portion 33 of the door outer panel 32 are separated along the vehicle width direction. In this gap, a downstream opening 46 of the tubular member (the air duct 50 and the protector 40) is arranged.

Further, referring to FIG. 6, an end portion 21A is provided in the side plate portion 21 of the fender panel 20. The end portion 21A indicates an area of the fender panel 20 on the side door 30 side. That is, the end portion 21A is close to the side door 30.

An end portion 21A is coupled to the flanges 42 of the protector 40. As will be described later, the flange 42 constitutes a tube end portion 47A of the tubular member. That is, the end portion 21A of the fender panel 20 is coupled to the tube end portion 47A. This coupling suppresses deformation of the end portion 21A due to thermal expansion.

### 4. Case

Referring to FIGS. 3 and 4, a protector 40 is provided on an inner surface of the fender panel 20. Here, the inner surface of the fender panel 20 refers to the rear surface of the outer surface which is the design surface. The protector 40 is made of, for example, a resin material such as polypropylene.

The protector 40 includes a main surface portion 41. The main surface portion 41 is a plate-shaped portion extending in the vehicle width direction. As illustrated in FIG. 6, the main surface portion 41 faces the edge 32A of the door outer panel 32.

A downstream opening 46 is formed in the main surface portion 41. For example, the downstream opening 46 is passed through along the thickness direction of the main surface portion 41. Referring to FIGS. 3 and 5, the downstream opening 46 is an open area surrounded by the upper wall 46A, the lower wall 46B, and the flanges 42 and 43.

Referring to FIG. 3, the opening width of the downstream opening 46 along the vehicle width direction is different along the vehicle up-down direction. For example, the outside of the downstream opening 46 in the vehicle width direction is formed linearly along the shape of the side plate portion 21 of the fender panel 20. On the other hand, along the shape of the side plate portion 33 of the door outer panel 32 (see FIG. 2), the vehicle width direction inner side of the downstream opening 46 has an arc shape. That is, the downstream opening 46 has the widest width at the center portion in the up-down direction.

Referring to FIG. 5, flanges 42, 43, and 44 are formed on the main surface portion 41. Each of the flanges 42, 43, and 44 extends from the main surface portion 41 toward the front of the vehicle. A flange 42 is provided at an outer end portion of the main surface portion 41 in the vehicle width direction. The flange 43 sandwiches the downstream opening 46 together with the flange 42. The flange 44 is disposed at an inner end portion of the main surface portion 41 in the vehicle width direction.

As illustrated in FIGS. 2 and 6, a region of the main surface portion 41 between the flange 43 and the flange 44 is hidden by the side door 30 (the door outer panel 32). A clip-hole 41A is drilled between the flange 43 and the flange 44. Further, the downstream opening 46 is disposed outside the outer surface of the side door 30 (door outer panel 32) in the vehicle width direction.

Referring to FIG. 6, the clip 90 is inserted into the clip hole 41A. The clip 90 fastens the main surface portion 41 and the bracket 74. An inner side of the bracket 74 in the vehicle width direction is fixed to the A pillar 70. For example, the vehicle width direction inner side of the bracket 74 is welded to the A-pillar outer 72.

Referring to FIG. 5, for example, the main surface portion 41 extends from the upper plate portion 22 of the fender panel 20 to the flange 24. Similarly, the flanges 42, 43, and 44 extend from the upper plate portion 22 of the fender panel 20 to the flange 24. Referring to FIG. 6, the flange 42 is coupled to the end portion 21A of the side plate portion 21 via the adhesive tape 62. That is, the end portion 21A of the fender panel 20 is restrained by the flanges 42 over the entire up-down direction area. This restraint configuration suppresses deformation of the end portion 21A due to thermal expansion.

Referring to FIG. 5, a plurality of rectifying plates 45 are provided between the flanges 42 and 43. The rectifying plate 45 extends horizontally, for example, along the vehicle front-rear direction. The plurality of rectifying plates 45 are disposed at the downstream opening 46 at intervals along the vehicle up-down direction.

As described above, the opening width of the downstream opening 46 along the vehicle width direction is different along the vehicle up-down direction. Therefore, the width dimensions of the plurality of rectifying plates 45 are also different. For example, the rectifying plate 45A is disposed at a position of the downstream opening 46 where the opening is largest. This arrangement suppresses deformation of the downstream opening 46.

Further, the plurality of rectifying plates 45 arrayed in the up-down direction includes an uppermost rectifying plate 45B and a lowermost rectifying plate 45C. These rectifying plate 45B, 45C and the flanges 42, 43 form a tubular construction. This cylindrical structure is connected to the rear end of the air duct 50 (see FIG. 4). The rectifying plate 45B corresponds to the upper wall 46A of FIG. 3. The rectifying plate 45C corresponds to the lower wall 46B of FIG. 3.

Referring to FIGS. 4 and 6, the flange 43 is coupled to the flange 55 of the air duct 50. For example, the flanges 43, 55 are connected via an adhesive tape 64.

Referring to FIG. 6, the sealing material 60 is sandwiched between the flange 44 and the A-pillar outer 72. For example, a sealing material 60 having a predetermined thickness is sandwiched between the flange 44 and the A-pillar outer 72 in a collapsed state. Accordingly, the entry of water from the motor compartment 80 is suppressed.

### 5. Air Duct

Referring to FIGS. 1 and 4, the air duct 50 is disposed on the vehicle width direction inner side of the fender panel 20. The air duct 50 is a square tube having a rectangular cross section. An upstream opening 52 is provided at a front end of the air duct 50. The upstream opening 52 is aligned with the opening 85A of the fender liner 85. That is, the air in the wheel house 19 flows into the air duct 50 through the upstream opening 52.

A flange 51 is formed around the upstream opening 52 in the air duct 50. Referring to FIG. 6, the flange 51 is fastened to the fender liner 85 by the clip 91.

A connection opening 54 is formed in the rear end of the air duct 50. The connection opening 54 is aligned with the downstream opening 46 of the protector 40.

The air duct 50 is provided with a flange 55. The flange 55 extends rearwardly from the connection opening 54. The flange 55 is coupled to the flange 43 of the protector 40. For example, as described above, the flanges 43, 55 are coupled via an adhesive tape 64.

As described above, the outer flanges 42 of the protector 40 are coupled to the end portion 21A of the fender panel 20. Thus, for example, the air duct 50 is coupled to the protector 40 only by the flanges 43, 55.

Referring to FIGS. 1 and 4, the air duct 50 has a section on the upstream side larger than a section on the downstream side. Further, the bottom surface 53 of the air duct 50 is inclined ascending from the upstream side toward the downstream side.

The upstream opening 52 is arranged rearward of the wheel 15. Therefore, water wound up by the wheel 15 may enter the air duct 50. When the bottom surface 53 is inclined upward, the progress of water is suppressed. Accordingly, the water in the air duct 50 is prevented from being discharged from the downstream opening 46. As a result, adhesion of water to the door outer panel 32 is suppressed.

### 6. Tubular Member

Referring to FIGS. 4 and 6, the air duct 50 and the protector 40 constitute a tubular member. That is, the air duct 50 and the protector 40 constitute a tubular member that communicates from the upstream opening 52 of the air duct 50 to the downstream opening 46 via the connection opening 54. In other words, the upstream opening 52 is formed at the upstream end of the tubular member. Further, a downstream opening 46 is formed at a downstream end of the tubular member. The tubular member is disposed inside the fender panel 20 in the vehicle width direction. The tubular member extends in the vehicle front-rear direction. Still referring to FIG. 6, the tubular member is fixed to the front end and the rear end of the fender panel 20.

Since the tubular member is a divided body of the air duct 50 and the protector 40, it is possible to flexibly cope with the size change of the air duct 50. For example, the distance from the wheel 15 (see FIG. 1) to the side door 30 varies depending on the vehicle type. By preparing the air ducts 50 of various lengths, it is possible to cope with a change in the distance between the wheel 15 and the side door 30 without changing the protector 40.

Further, the front end and the rear end of the fender panel 20 are connected by a tubular member. As a result, thermal expansion of the fender panel 20 in the vehicle front-rear direction is suppressed. Accordingly, even if the gap between the door outer panel 32 and the fender panel 20 is narrowed, interference between the two is suppressed.

### 7. Vehicle Rear Structure

In the embodiment of FIGS. 1-6, the fender panel 20 corresponds to a front fender. The side door 30 corresponds to a front door. Alternatively, the fender panel 20 may be a rear fender. The side door 30 may be a rear door. In this case, the fender panel 20 is disposed behind the side door 30.

For example, when the mounting structure of the internal combustion engine is a so-called midship type or a rear engine type, a side intake is formed in the rear fender. The rear fender may be made of resin, and the side intake may be made of the above-described tubular member (the air duct 50 and the protector 40).

In this case, the tubular member is disposed inside the fender panel 20 in the vehicle width direction. The protector 40, which is a part of the tubular member, is close to the rear end of the door outer panel 32. Further, an air duct 50 is connected downstream of the protector 40.

Also in this case, the flange 42 (see FIG. 6) of the protector 40 restrains the end portion 21A of the fender panel 20 in the up-down direction. Therefore, deformation due to thermal expansion of the end portion 21A is suppressed.

### 8. First Example of This Embodiment

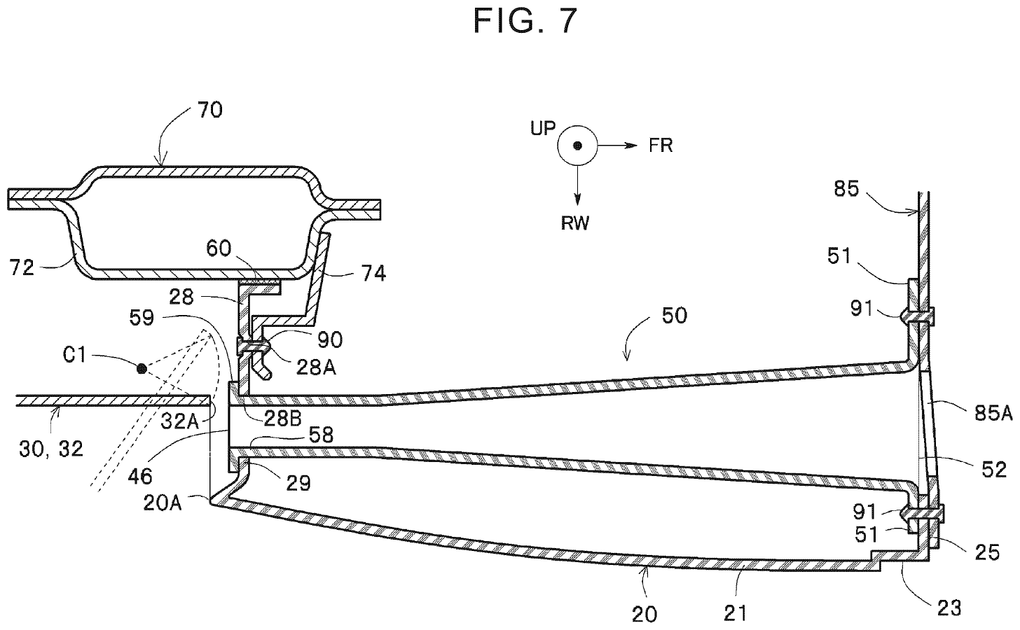

FIG. 7 shows a first alternative example of the fender structure according to the present embodiment. In this example, the tubular member is constituted only by the air duct 50. A downstream opening 46 is formed in the rear end of the air duct 50. The downstream opening 46 is surrounded by a tube end portion 58.

A flange 28 is formed at the rear end of the fender panel 20. The flange 28 extends inward in the vehicle width direction from the rear end of the side plate portion 21. More specifically, the fender panel 20 is folded back to the front of the vehicle from the rear end of the side plate portion 21. The flange 28 extends in the vehicle width direction from the folded-back portion.

A clip-hole 28A is drilled in the flange 28. When the clip 90 is inserted into the clip hole 28A, the flange 28 is fastened to the bracket 74.

In addition, an opening 28B is drilled in the flanges 28. The opening 28B is aligned with the downstream opening 46 of the air duct 50. A flange 59 is formed around the downstream opening 46. The flange 59 is coupled to the flange 28 of the fender panel 20. For example, the flanges 28, 59 are welded.

Also in such a structure, the end portion 29 of the fender panel 20 is coupled to the tube end portion 58 of the air duct 50 which is a tubular member. That is, the end portion 29 is restrained by the air duct 50. As a result, deformation of the end portion 29 due to thermal expansion is suppressed.

What is claimed is:

1. A fender structure of a vehicle, the fender structure comprising:
a fender panel that is made of resin and that is adjacent to a side door of the vehicle in a vehicle front-rear direction; and
a tubular member that is disposed on an inner side from the fender panel in a vehicle width direction, extending in the vehicle front-rear direction, and that includes an opening directed toward the side door, wherein
a tube end portion of the tubular member surrounding the opening is joined to an end portion of the fender panel, on a side of the fender panel toward the side door.

2. The fender structure according to claim 1, wherein
the opening of the tubular member is disposed on an outer side of an outer face of a door outer panel of the side door in the vehicle width direction, and
positions of an edge of the fender panel on the side of the fender panel toward the side door and an edge of the door outer panel on a side of the door outer panel toward the fender panel are aligned in the vehicle front-rear direction.

3. The fender structure according to claim 2, wherein
the side door is a front door,
the fender panel is disposed forward from the front door,
an upstream opening facing a wheel house is fashioned at an upstream end of the tubular member, and
a bottom face of the tubular member is inclined ascending from an upstream side toward a downstream side.

4. The fender structure according to claim 3, wherein
an opening width of the opening on the downstream side of the tubular member along the vehicle width direction varies along a vehicle up-down direction, and
a rectifying plate is disposed at a portion where the opening width is greatest in the opening on the downstream side of the tubular member.

5. The fender structure according to claim 1, wherein the tube end portion of the tubular member and the end portion of the fender panel are joined by adhesive tape.

6. A fender structure for a vehicle, the fender structure comprising:
a side door of the vehicle, the side door including an outer panel that is made of metal,
a fender panel that is made of resin and that is provided adjacent to either forward or rearward of the side door in a vehicle front-rear direction, and
a tubular member that is disposed on an inner side of the fender panel in a vehicle width direction, and that is fixed to a front end and a rear end of the fender panel, wherein
an opening at a front end or a rear end of the tubular member is directed in a direction along an outer face of the outer panel of the side door.
